(19) United States
(12) Patent Application Publication
(10) Pub. No.: US 2018/0239856 A1
(43) Pub. Date: Aug. 23, 2018

(54) FIELD-PROGRAMMABLE GATE ARRAY BASED EMULATION SYSTEM AND METHOD THEREFOR

(71) Applicant: NXP USA, INC., AUSTIN, TX (US)

(72) Inventors: MARK T. TAKEUCHI, AUSTIN, TX (US); MICKY KOWLESSAR, CEDAR PARK, TX (US); EDUARDO GUDIS, AUSTIN, TX (US)

(21) Appl. No.: 15/441,044

(22) Filed: Feb. 23, 2017

(51) Int. Cl. G06F 17/50

(52) U.S. Cl. CPC G06F 17/5027

(57) ABSTRACT

An emulation system is provided for emulating a hardware architecture. The system includes a system board. The system board includes a host processor, a switching circuit, and a system controller. The switching circuit is bidirectionally coupled to the host processor. The system controller is coupled to the switching circuit. The system controller is configured to receive a slot ID from one of a plurality of slots on a backplane of a chassis, and in response to the slot ID, the system controller configures the switching circuit to connect the host processor to communicate with a plurality of board devices either through the backplane or directly as a stand-alone emulation system board, thus allowing the system board to function in a chassis with other boards or to function as a standalone board.

### BACKGROUND

### Field

This disclosure relates generally to electronic circuits and more specifically to a field-programmable gate array (FPGA) based emulation system and method therefor.

### Related Art

Field-programmable gate array based emulation systems are used to develop and prototype various integrated circuit based designs such as processors and system on a chip (SoC) integrated circuits. Typically, the FPGA based emulation system includes a multi-slot chassis and one or more system boards that are inserted into the chassis. Hardware development is carried out by interconnecting the logic gates and other components of the system boards. The number of system boards used depends on the complexity and size of the design. For small designs, only a single system board may be inserted into the multi-slot chassis.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates, in block diagram form, an emulation system configured with one system board in a backplane in accordance with an embodiment.

FIG. 2 illustrates, in block diagram form, the emulation system of FIG. 1 configured with one master system board and one slave system board in a backplane in accordance with another embodiment.

FIG. 3 illustrates, in block diagram form, the emulation system of FIG. 1 with a system board configured to operate without a backplane in accordance with an embodiment.

FIG. 4 illustrates, in block diagram form, a slot ID table in accordance with an embodiment.

FIG. 5 illustrates, in partial block diagram form and partial schematic diagram form, a circuit for generating a slot ID in accordance with an embodiment.

### DETAILED DESCRIPTION

Generally, there is provided, an FPGA based system board for emulating and prototyping ASIC and SOC designs to be used either in a multi-board chassis or as a stand-alone single board. The system board can be used as a stand-alone board without the need for additional hardware or software modification. A host processor connects to board devices through a PCIe switch, a switch/multiplexer circuit, and a system controller. A slot ID from the backplane of the chassis is used by the system controller to detect if a system board is installed in a slot and to configure the system accordingly. For example, if the slot ID signal indicates that the emulation system board is inserted into one of the plurality of slots as one of a plurality of emulation system boards, a switching circuit on the emulation system board is configured to cause a host processor on the emulation system board to communicate with board devices on each of the emulation system boards through the backplane. If the slot ID signal indicates that the emulation system board is the only emulation system board inserted into one of the plurality of slots, the switching circuit on the emulation system board causes the host processor to connect with board devices on the emulation system board through the backplane. If the slot ID signal indicates that the emulation system board is not inserted into one of the plurality of slots, the switching circuit on the emulation system board causes the host processor to connect with board devices of the emulation system board. In this manner, an emulation system board can be used in a chassis, with or without other boards, or standalone, without the use of a chassis when emulating relatively small designs.

In one embodiment, there is provided, an emulation system board for use in an emulation system for emulating a hardware architecture, the emulation system board comprising: a host processor; a switching circuit bidirectionally coupled to the host processor; and a system controller, coupled to the switching circuit, the system controller configured to receive a slot ID from one of a plurality of slots on a backplane of a chassis, and in response to the slot ID, the system controller configuring the switching circuit to connect the host processor to communicate with a plurality of board devices either through the backplane or directly as a stand-alone emulation system board. In response to the system controller detecting that the emulation system board is not connected to the backplane, the system controller providing a select signal to configure the switching circuit, the switching circuit provides a connection between the host processor and one or more of the plurality of board devices on the emulation system board. In response to the system controller detecting that the emulation system board is solely connected with the backplane through one of the plurality of slots, the switching circuit is configured to provide a connection between the host processor and one or more of the plurality of board devices on the emulation system board through the one of the plurality of slots. In response to the system controller detecting that the emulation system board is one of a plurality of emulation system boards connected to the backplane, the switching circuit is configured to provide a connection between the host processor and one or more of the plurality of board devices on each of the emulation system boards through corresponding slots in the backplane. The emulation system board may further comprise a peripheral component interconnect express (PCIe) switch bidirectionally coupled between the host processor and the switching circuit. The slot ID may be a multi-bit digital signal for identifying each of the plurality of slots in the backplane. The plurality of board devices may comprise one or more logic circuits and one or more analog circuits for use in emulating a system design. The plurality of board devices may comprise one or more logic gate arrays, memory arrays, phase lock loops, multipliers, or input/output circuits. The plurality of board devices may be located on the emulation system board.

In another embodiment, there is provided, an emulation system board for use in an emulation system for emulating a hardware architecture, the emulation system board comprising: a host processor; a peripheral component interconnect express (PCIe) switch bidirectionally coupled to the host processor; a switching circuit bidirectionally coupled to the PCIe switch; and a system controller, bidirectionally coupled to the switching circuit, the system controller configured to receive a slot ID from one of a plurality of slots on a backplane of a chassis, and in response to the slot ID, the system controller configuring the switching circuit to connect the host processor to communicate with a plurality of board devices either through the backplane or directly as a stand-alone emulation system board. In response to the system controller detecting that the emulation system board is not connected to the backplane, the system controller to provide a select signal to configure the switching circuit, the switching circuit to provide a connection between the host processor and one or more of the plurality of board devices on the emulation system board. In response to the system controller detecting that the emulation system board is solely connected with the backplane through one of the plurality of slots, the switching circuit is configured to provide a connection between the host processor and one or more of the plurality of board devices on the emulation system board through the one of the plurality of slots. In response to the system controller detecting that the emulation system board is one of a plurality of emulation system boards connected to the backplane, the switching circuit is configured to provide a connection between the host processor and one or more of the plurality of board devices on each of the emulation system boards through corresponding slots in the backplane. The emulation system board may further comprise a peripheral component interconnect express (PCIe) switch bidirectionally coupled between the host processor and the switching circuit. The slot ID may be a multi-bit digital signal for identifying each of the plurality of slots in the backplane. The plurality of board devices may comprise one or more logic circuits and one or more analog circuits for use in emulating a system design. The plurality of board devices may comprise one or more logic gate arrays, memory arrays, phase lock loops, multipliers, or input/output circuits. The plurality of board devices may be located on the emulation system board.

In yet another embodiment, there is provided, a method for operating an emulation system board for emulating a hardware architecture, the method comprising: receiving a slot ID signal; determining if the slot ID signal indicates that the emulation system board is inserted into one of a plurality of slots on a backplane in a chassis, if the slot ID signal indicates that the emulation system board is inserted into one of the plurality of slots as one of a plurality of emulation system boards, configuring a switching circuit on the emulation system board to cause a host processor on the emulation system board to communicate with board devices on each of the emulation system boards, if the slot ID signal indicates that the emulation system board is the only emulation system board inserted into one of the plurality of slots, causing the switching circuit on the emulation system board to connect the host processor with board devices on the emulation system board through the backplane, and if the slot ID signal indicates that the emulation system board is not inserted into one of the plurality of slots, causing the switching circuit on the emulation system board to connect the host processor with board devices of the emulation system board. The slot ID signal may further indicate which slot of the plurality of slots the emulation system board is inserted into.

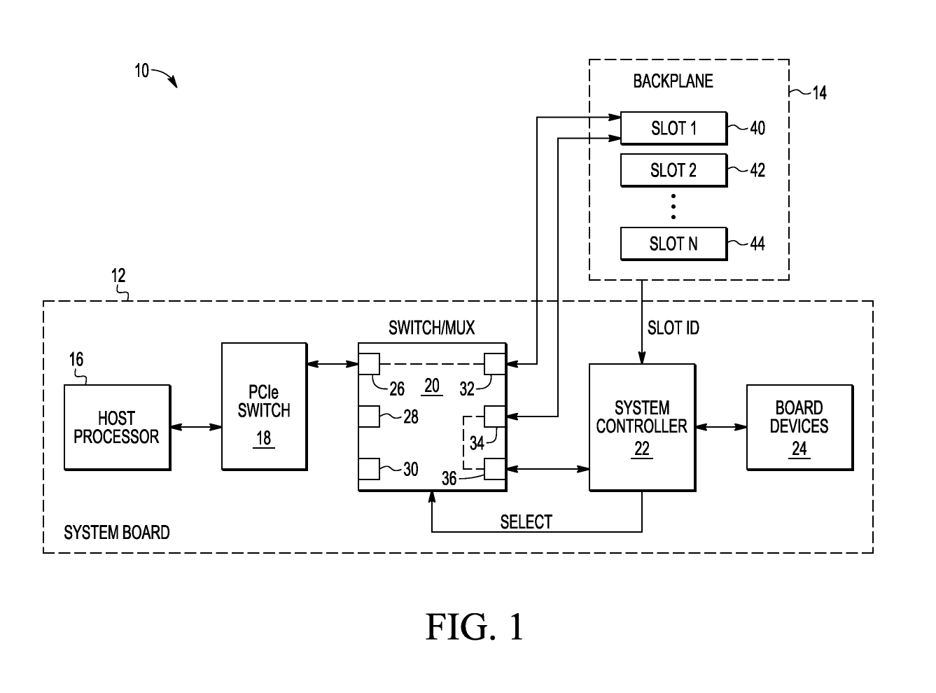

FIG. 1 illustrates, in block diagram form, emulation system 10 configured with one system board in a backplane according to an embodiment. Emulation system 10 includes emulation system board 12, and backplane 14. Emulation system board 12 is a master system board and includes host processor 16, peripheral component interconnect express (PCIe) switch 18, switch/multiplexer 20, system controller 22, and board devices 24. Switch/multiplexer 20 includes a plurality of ports 26, 28, 30, 32, 34, and 36. Backplane 14 includes a plurality of slots represented by slots 40, 42, and 44. Each of the plurality of slots is for providing a connection point to a plurality of connectors on one emulation system board. In one embodiment, the emulation system board may comprise a number of components mounted on a printed circuit board (PCB). In another embodiment, the emulation system board may be formed differently.

In emulation system board 12, host processor 16 is bidirectionally connected to PCIe switch 18. PCIe switch 18 is bidirectionally connected to port 26 of switch/multiplexer 20. System controller 22 has an output terminal for providing a select signal SELECT to an input of switch/multiplexer 20 and an input terminal for receiving a slot ID signal from backplane 14. A slot ID is unique to each of the plurality of slots in backplane 14. System controller 22 is bidirectionally connected to port 36 of switch/multiplexer 20. In one embodiment, a switch/multiplexer having part number CBTU04082, available from NXP Semiconductor, Inc. is used for switch/multiplexer 20. Switch/multiplexer 20 is configured to provide signal routing between the ports in response to select signal SELECT. System controller 22 is also bidirectionally connected to board devices 24. Board devices 24 provides a number of different circuits for use in emulating or prototyping various circuit elements. For example, board devices 24 may include one or more logic gate arrays, one of more memory arrays, a phase lock loop, multipliers, and input/output circuits. In an emulation system, the board devices are connected to emulate or prototype a circuit or system being developed. This allows a circuit or system designer to see how a design will operate and to develop firmware, software, and accessories to run on the design.

Backplane 14 is configured to accept one master emulation system board and a number of slave system boards. The master emulation system board is inserted into a particular slot in backplane 14, for example, slot 40 in backplane 14, labeled “SLOT 1”. Only one master emulation system board with a host processor is needed. The number of slave boards inserted into backplane 14 is determined by, at least in part, the size of the system being emulated. The slave system boards are generally the same as a master system board except that slave system boards lack a host processor.

In operation, each slot of backplane 14 is identified by a slot identifier (ID). In one embodiment, a specific slot ID comprising a multi-bit digital signal is assigned to each slot. When system board 12 is inserted into a slot, the slot ID signal is provided to system controller 22. System controller 22 asserts select signal SELECT depending on whether system board 12 is operating within a chassis or is operating as a standalone board. The select signal SELECT is a single bit signal that is set high when system board 12 is not installed in a slot, and the select signal SELECT is set low when system board 12 is installed in a slot. In the example illustrated in FIG. 1, based on the slot ID, system controller 22 asserts the select signal SELECT low to automatically configure switch/multiplexer 20 to route the communication connections between board 12 and backplane 14. In FIG. 1, as can be seen by dashed lines in switch/multiplexer 20, host processor 16 is connected through ports 26 and 32 to slot 40, and slot 40 is connected to system controller 22 through ports 34 and 36. In other embodiments, different connections switch/multiplexer 20 may be made to accomplish the same result.

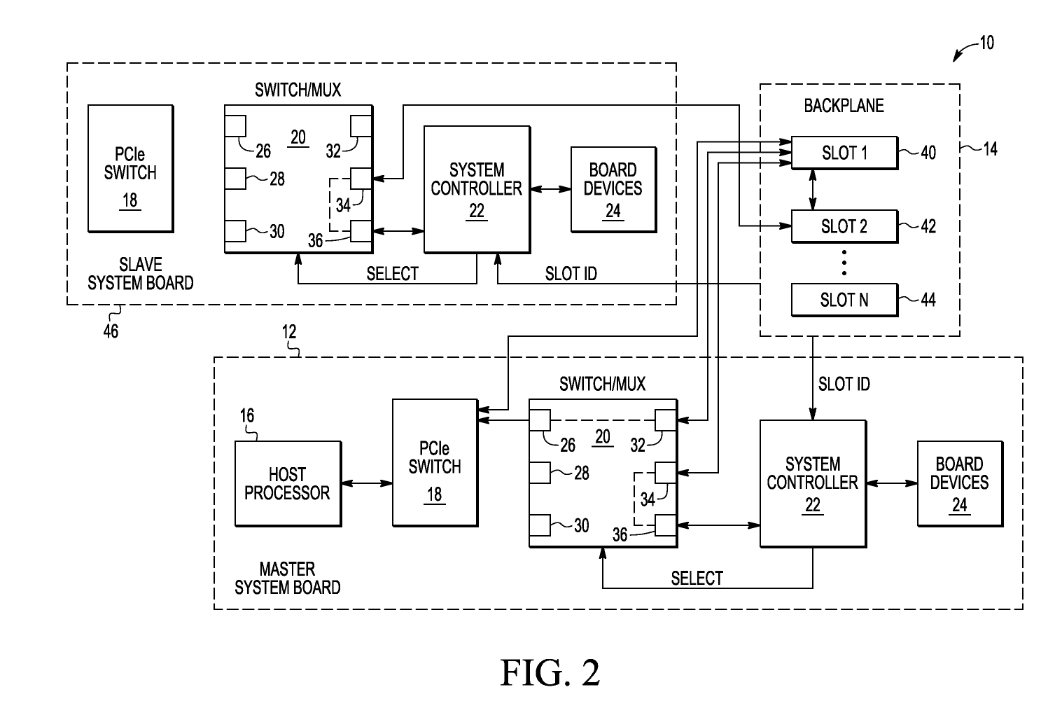

FIG. 2 illustrates, in block diagram form, the emulation system of FIG. 1 configured with one master system board 12 and one slave system board 46 connected to backplane 14 in accordance with another embodiment. In FIG. 2, master system board 12 is the same as system board 12 in FIG. 1, except in FIG. 2, system board 12 is now inserted in backplane 14 and functioning as a master system board with slave system board 46. Because the boards are inserted in backplane 14, the connections in switch/multiplexer 20 are the same. When inserted into slot 40, master system board 12 has a PCIe connection from host processor 16 to slot 40 through switch/multiplexer 20. Slave system board 46 is inserted into slot 42 (SLOT 2). System controller 22 of master system board 12 receives a slot ID signal from slot 40 (SLOT 1). In response, switch/multiplexer 20 is automatically configured to correctly route the signals for the detected number of inserted system boards. Specifically, select signal SELECT from system controller 22 is set as a logic low causing a connection to be made in switch/multiplexer 20 between ports 34 and 36 to connect slot 40 to board devices 24 via system controller 22. Also, a slot ID signal is received by system controller 22 of slave system board 46. Select signal SELECT of slave system board 46 is set low to cause ports 34 and 36 of switch/multiplexer 20 to connect slot 42 to board devices 24 through system controller 22 of slave system board 46. Any number of slave system boards 46 can be inserted into backplane 14, up to the total number of slots N. In one embodiment, backplane 14 has 14 slots.

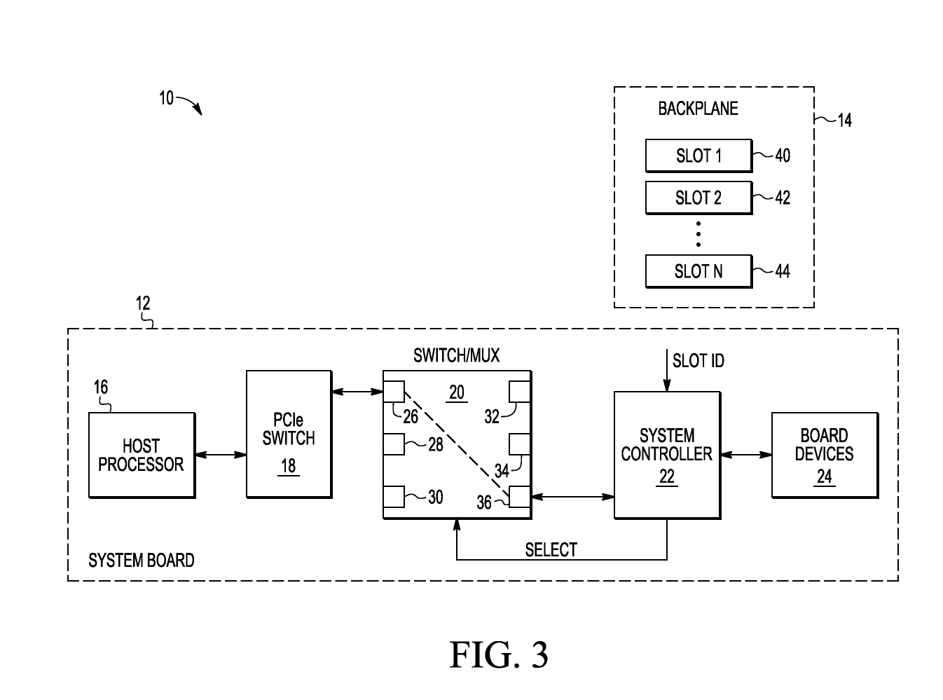

FIG. 3 illustrates, in block diagram form, emulation system 10 of FIG. 1 with system board 12 configured to operate without backplane 14 in accordance with an embodiment. System board 12 is powered up without being inserted into a slot of backplane 14. System controller 22 does not detect a slot ID, so system controller 22 sets select signal SELECT to a logic high. The logic high select signal causes switch/multiplexer 20 to connect port 26 to port 36, thus routing host processor 16 through PCIe switch 18 to system controller 22 and board devices 24. In this manner, switch/multiplexer 20 allows system board 12 to have the flexibility to be used in a chassis or as a standalone board, freeing up the chassis for use with more complex and larger designs.

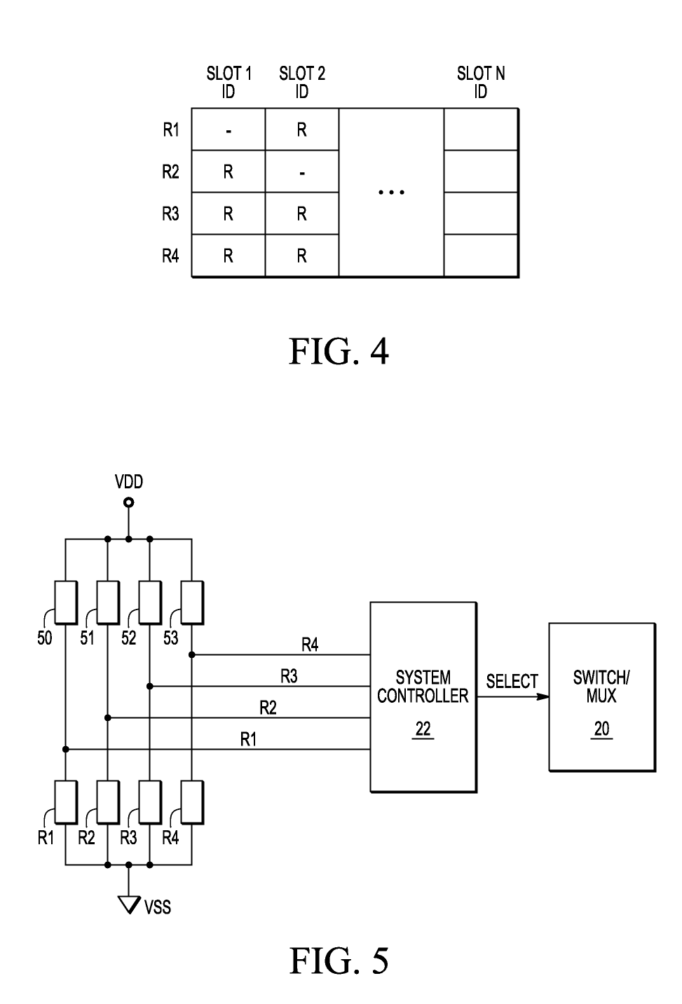

FIG. 4 illustrates, in block diagram form, a slot ID table in accordance with an embodiment. In the illustrated embodiment, the slot ID is a four-bit signal, allowing up to 16 slots to have a unique identifier. A resistor R is inserted between the bit position and ground to cause the bit position to indicate a logic low. For example, for the slot 1 ID, a resistor R is inserted in bit positions R2-R4, causing R2-R4 to be sensed as a logic zero. Bit position R1 does not have a resistor installed, causing that bit position to indicate a logic high. Likewise, the slot 2 ID has a resistor R in bit positions R1, R3, and R4. The bit position R2 does not have a resistor installed, causing that bit position to indicate a logic high. In the illustrated embodiment, a received slot ID that has all ones indicates that the system board is not inserted in a slot and should function as a standalone board. The slot N ID would have resistors installed (not shown) to provide a unique ID for a corresponding slot.

FIG. 5 illustrates, in partial block diagram form and partial schematic diagram form, a slot ID circuit for generating a slot ID in accordance with an embodiment. The slot ID circuit includes resistors 50-53 connected between a power supply voltage terminal VDD and bit positions on conductors labeled R1-R4, respectively. Resistors R1, R2, R3, and R4 are connected between VSS and terminals of resistors 50-53, respectively. The conductors R1-R4 collectively comprise the slot ID. As discussed above, the slot ID is provided to a system controller 22 when the system board is inserted into a slot of the backplane. Based on the existence of a slot ID with a low value, a select signal SELECT is provided to switch/multiplexer 20. Any number of slot IDs can be generated by increasing the number of conductors. The power supply voltage at VDD may be a positive power supply voltage and VSS may be ground. In other embodiments, VDD and VSS may be different.

In one embodiment, resistors 50-53 have a relatively high resistance value of about 10K ohms. Resistors R1-R4 have a relatively lower resistance value of about 1K ohms. When a resistor R1-R4 is inserted in a bit position, the lower value resistance causes the voltage at the corresponding R1-R4 input of system controller 22 to be pulled low to VSS. If the resistor R1-R4 is not inserted, then the corresponding R1-R4 input of system controller 22 remains high, or substantially VDD. In other embodiments, other circuits for generating a slot ID may be used.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims. Generally, in the above described embodiment, a current electrode is a source or drain and a control electrode is a gate of a metal-oxide semiconductor (MOS) transistor. Other transistor types may be used in other embodiments.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. An emulation system board for use in an emulation system for emulating a hardware architecture, the emulation system board comprising:
a host processor;
a switching circuit bidirectionally coupled to the host processor; and
a system controller, coupled to the switching circuit, the system controller configured to receive a slot ID from one of a plurality of slots on a backplane of a chassis, and in response to the slot ID, the system controller configuring the switching circuit to connect the host processor to communicate with a plurality of board devices either through the backplane or directly as a stand-alone emulation system board.

2. The emulation system board of claim 1, wherein in response to the system controller detecting that the emulation system board is not connected to the backplane, to provide a select signal to configure the switching circuit to provide a connection between the host processor and one or more of the plurality of board devices on the emulation system board.

3. The emulation system board of claim 1, wherein in response to the system controller detecting that the emulation system board is solely connected with the backplane through one of the plurality of slots, configuring the switching circuit to provide a connection between the host processor and one or more of the plurality of board devices on the emulation system board through the one of the plurality of slots.

4. The emulation system board of claim 1, wherein in response to the system controller detecting that the emulation system board is one of a plurality of emulation system boards connected to the backplane, configuring the switching circuit to provide a connection between the host processor and one or more of the plurality of board devices on each of the emulation system boards through corresponding slots in the backplane.

5. The emulation system board of claim 1, further comprising a peripheral component interconnect express (PCIe) switch bidirectionally coupled between the host processor and the switching circuit.

6. The emulation system board of claim 1, wherein the slot ID is a multi-bit digital signal for identifying each of the plurality of slots in the backplane.

7. The emulation system board of claim 1, wherein the plurality of board devices comprises one or more logic circuits and one or more analog circuits for use in emulating a system design.

8. The emulation system board of claim 1, wherein the plurality of board devices comprises one or more logic gate arrays, memory arrays, phase lock loops, multipliers, or input/output circuits.

9. The emulation system board of claim 1, wherein the plurality of board devices is located on the emulation system board.

10. An emulation system board for use in an emulation system for emulating a hardware architecture, the emulation system board comprising:
a host processor;
a peripheral component interconnect express (PCIe) switch bidirectionally coupled to the host processor;
a switching circuit bidirectionally coupled to the PCIe switch; and
a system controller, bidirectionally coupled to the switching circuit, the system controller configured to receive a slot ID from one of a plurality of slots on a backplane of a chassis, and in response to the slot ID, the system controller configuring the switching circuit to connect the host processor to communicate with a plurality of board devices either through the backplane or directly as a stand-alone emulation system board.

11. The emulation system board of claim 10, wherein in response to the system controller detecting that the emulation system board is not connected to the backplane, to provide a select signal to configure the switching circuit to provide a connection between the host processor and one or more of the plurality of board devices on the emulation system board.

12. The emulation system board of claim 10, wherein in response to the system controller detecting that the emulation system board is solely connected with the backplane through one of the plurality of slots, configuring the switching circuit to provide a connection between the host processor and one or more of the plurality of board devices on the emulation system board through the one of the plurality of slots.

13. The emulation system board of claim 10, wherein in response to the system controller detecting that the emulation system board is one of a plurality of emulation system boards connected to the backplane, configuring the switching circuit to provide a connection between the host processor and one or more of the plurality of board devices on each of the emulation system boards through corresponding slots in the backplane.

14. The emulation system board of claim 10, further comprising a peripheral component interconnect express (PCIe) switch bidirectionally coupled between the host processor and the switching circuit.

15. The emulation system board of claim 10, wherein the slot ID is a multi-bit digital signal for identifying each of the plurality of slots in the backplane.

16. The emulation system board of claim 10, wherein the plurality of board devices comprises one or more logic circuits and one or more analog circuits for use in emulating a system design.

17. The emulation system board of claim 10, wherein the plurality of board devices comprises one or more logic gate arrays, memory arrays, phase lock loops, multipliers, or input/output circuits.

18. The emulation system board of claim 10, wherein the plurality of board devices is located on the emulation system board.

19. A method for operating an emulation system board for emulating a hardware architecture, the method comprising:
receiving a slot ID signal;
determining if the slot ID signal indicates that the emulation system board is inserted into one of a plurality of slots on a backplane in a chassis,
if the slot ID signal indicates that the emulation system board is inserted into one of the plurality of slots as one of a plurality of emulation system boards, configuring a switching circuit on the emulation system board to cause a host processor on the emulation system board to communicate with board devices on each of the emulation system boards,
if the slot ID signal indicates that the emulation system board is the only emulation system board inserted into one of the plurality of slots, causing the switching circuit on the emulation system board to connect the host processor with board devices on the emulation system board through the backplane, and
if the slot ID signal indicates that the emulation system board is not inserted into one of the plurality of slots, causing the switching circuit on the emulation system board to connect the host processor with board devices of the emulation system board.

20. The method of claim 19, wherein the slot ID signal further indicates which slot of the plurality of slots the emulation system board is inserted into.
